(19) United States
(12) Patent Application Publication
(10) Pub. No.: US 2007/0287051 A1
(43) Pub. Date: Dec. 13, 2007

(54) POLYMER ELECTROYTE MEMBRANE, MEMBRANE/ELECTRODE ASSEMBLY AND FUEL CELL USING THE ASSEMBLY

(76) Inventors: Atsuhiko Onuma, Hitachi (JP); Hidetoshi Honbou, Hitachinaka (JP); Toshiyuki Kobayashi, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/627,524

(22) Filed: Jan. 26, 2007

(30) Foreign Application Priority Data
Jun. 8, 2006 (JP) 2006-159202

(51) Int. Cl. H01M 8/10

(52) U.S. Cl. 429/33; 429/30

(57) ABSTRACT

Disclosed is an electrolyte membrane which is slowly degraded by a peroxide occurring at an air electrode catalyst layer, is low in cost, and is long in life, and a membrane electrode assembly. The electrolyte membrane has a first electrolyte layer which has an ion conductivity, a second electrolyte layer which has an ion conductivity, and, upon surface contact with methanol, is thicker than the first electrolyte layer, has a larger ion exchange equivalent, or a larger number average molecular weight, and a porous layer which has an ion conductive electrolyte impregnated therein, formed between the first electrode layer and the second electrode layer.

### CLAIM OF PRIORITY

The present application claims priority from Japanese application serial No. 2006-159202, filed on Jun. 8, 2006, the content of which is hereby incorporated by reference into this application.

### FIELD OF THE INVENTION

The present invention relates to a solid polymer electrolyte membrane, a membrane-electrode assembly (which is hereinafter abbreviated as a MEA), and a solid polymer type fuel cell (which is hereinafter abbreviated as a PEFC), and a direct methanol type fuel cell (which is hereinafter abbreviated as a DMFC).

### RELATED ART

A fuel cell is expected as a future new energy because of its low pollution performance and high energy efficiency. The fuel cell electrochemically oxidizes a fuel such as hydrogen or methanol by oxygen, and thereby converts the chemical energy of the fuel into the electrical energy, and extracts it.

The PEFC uses hydrogen as a fuel, operates at low temperatures, is high in output density, and can be reduced in size. For this reason, it has been under development in order to be applied to a distributed power source for home use, a distributed power source for business use, a mobile power source for automobiles, or the like. The DMFC uses methanol as a fuel, is high in output density, and is excellent in portability. For this reason, it has been under development as a power source for a mobile device such as a cellular phone. As a solid polymer electrolyte membrane of a fuel cell, there is used a fluorine-containing electrolyte membrane having a high proton conductivity such as Nafion® (manufactured by DuPont Co.), Aciplex® (manufactured by Asahi Kasei Corp.), or Flemion® (manufactured by Asahi Glass Co., Ltd.), or a hydrocarbon electrolyte membrane having an ion exchange group.

In order to achieve the performance improvement by an enhancement of efficiency, an increase in output density, or the like of the fuel cell, it is necessary to reduce the ion conduction resistance of the solid polymer electrolyte membrane, and improve the ion conductivity thereof. As a method for reducing the ion conduction resistance of the solid polymer electrolyte membrane, there is reduction of the membrane thickness. The reduction of the membrane thickness causes problems such as reduction of the mechanical strength of the membrane, and degradation of processability and handling.

In order to solve the problem, there is a method in which the electrolyte membrane is reinforced by a reinforcing material. Patent Document 1 discloses a solid polymer electrolyte composite membrane including a porous thin membrane made of polyolefin with a weight average molecular weight of 5×10⁵ or more, and an ion exchange resin filled in the pores thereof.

Incidentally, in the fuel cells, the following phenomenon occurs. Peroxide is formed in the electrode catalyst layer formed at the interface between the solid polymer electrolyte membrane and the electrode by the electrode reaction. The peroxide is radicalized to be a peroxide radical while being diffused, and erodes and degrades the electrolyte. The formation of the peroxide radical is particularly promoted by the metal ions (such as Fe²⁺ and Cu²⁺) eluted from the piping for feeding a supply fuel (a gas or a liquid), or a mist to be mixed to the supply fuel in order to keep the electrolyte in a wet state, or the like. Under such circumstances, various electrolyte materials excellent in oxidation resistance have been developed in order to avoid such a problem. Out of these, particularly, a perfluorosulfonic acid polymer known as Nafion from DuPont Co., is a perfluorinated electrolyte material, and has a C—F bond. Therefore, it is high in chemical stability, and hardly undergoes oxidation by a peroxide, and thus, it is regarded as being very excellent.

However, the fluorine-containing electrolyte membrane requires a large number of manufacturing steps, and hence it has a disadvantage of high material cost. This makes difficult the application to general uses. On the other hand, for the hydrocarbon electrolyte membrane, there is a polyether sulfonic acid resin membrane having a sulfonic acid group introduced therein disclosed in Patent Document 2, or the like.

However, the hydrocarbon electrolyte membrane has an advantage of easy manufacturing and a low cost as compared with the perfluorinated electrolyte membrane typified by Nafion. On the other hand, there remained problems that the membrane tends to be eroded by the peroxide formed by the electrode reaction, and that the oxidation resistance is low. The reason for this has been considered that the hydrocarbon framework tends to undergo the oxidation reaction by a peroxide. However, how the hydrogen peroxide degrades the solid polymer electrolyte membrane has not been made clear.

In Patent Documents 3 and 4, a layer containing a metal oxide, which is a hydrogen peroxide decomposing catalyst is formed midway between an electrode catalyst layer and an electrolyte layer, thereby to inhibit the degradation of the electrolyte membrane. However, with these membrane electrode assemblies, the effect of a longer life is small, and the ion conduction resistance of the electrolyte membrane becomes large because of charging of additives. Thus, the membrane manufacturing process becomes complicated, unfavorably resulting in a high cost.

[Patent Document 1] Japanese Patent Application Laid-Open Publication No. 64-22932

[Patent Document 2] Japanese Patent Application Laid-Open Publication No. 10-45913

[Patent Document 3] Japanese Patent Application Laid-Open Publication No. 2005-216701

[Patent Document 4] Japanese Patent Application Laid-Open Publication No. 2005-353408

In order to solve the problem, it is an object of the present invention to provide a low cost and long life electrolyte membrane and a membrane electrode assembly.

### SUMMARY OF THE INVENTION

In order to achieve the foregoing object, the present inventors conducted a continuous electricity production test of a DMFC by using a hydrocarbon solid polymer composite membrane having a porous layer including at least one layer of a porous material impregnated with an electrolyte on the inner sides of a pair of electrolyte layers. Then, the cross section of the solid polymer electrolyte membrane before and after the electricity production was observed. As a result, it has been indicated that the thickness of the electrolyte layer adjacent to the air electrode after the electricity production test was reduced as compared with that before the electricity production test. Thus, it has been shown that the main cause for the deterioration of the electrolyte membrane is the wall thickness loss. The reduction of the thickness of the electrolyte layer adjacent to the air electrode is considered to be caused in the following manner. Hydrogen peroxide radicals are formed from hydrogen peroxide formed at the air electrode catalyst layer, and decompose the main chain of the hydrocarbon electrolyte. This leads to a decrease in molecular weight to cause dissolution, resulting in wall thickness loss. For this reason, the present inventors found that the thickness of the electrolyte layer present between the air electrode catalyst layer and the porous layer largely affects the life of the electrolyte membrane.

However, a change in the total thickness of the solid polymer electrolyte composite membrane unfavorably causes an increase in ion conduction resistance of the solid polymer electrolyte composite membrane.

In view of the foregoing, the present inventors provide an electrolyte membrane, which has a porous layer including at least one layer of a porous material impregnated with an electrolyte on inner sides of a pair of electrolyte layers, wherein any of the thickness, the ion exchange group equivalent weight, and the average molecular weight of one electrolyte layer is made larger than that of the other, and an air electrode catalyst layer is formed on the electrolyte layer of which any of the thickness, the ion exchange group equivalent weight, and the average molecular weight is large, and a fuel electrode catalyst layer is formed on the other. This can provide a long life membrane electrode assembly, which has led to the present invention.

Whereas, the reactions on the air electrode side in the DMFC and the PEFC are the same. Therefore, it is considered that the cell performances are degraded by the same phenomenon also for the PEFC. Thus, it is considered that the present invention is also useful for the solid polymer electrolyte membrane for a PEFC.

In the present invention, the electrolyte membrane for use as an electrolyte membrane has no particular restriction so long as it is an electrolyte membrane having ion conductivity, and having a resistance to heat of equal to or more than the working temperature of the fuel cell.

The hydrocarbon polymer electrolyte for use as the electrolyte layer is preferably any of a polyether sulfone polymer compound, a polyether ether ketone polymer compound, a polyphenylene sulfide polymer compound, a polyphenylene ether polymer compound, a polysulfone polymer compound, and a polyether ketone polymer compound.

In the present invention, it is essential only that the thickness of one electrolyte layer of the electrolyte membrane having a porous layer including at least one layer of a porous material impregnated with an electrolyte on inner sides of a pair of electrolyte layers is larger than the thickness of the other electrolyte layer. In the electrolyte membrane for use in the present invention, the thickness of one electrolyte layer is 90 μm less, preferably 70 μm or less, and further preferably 10 to 40 μm. The thickness of the other electrolyte layer is 50 μm or less, preferably 30 μm or less, and further preferably 5 to 20 μm. The total thickness of the electrolyte composite membrane has no particular restriction, but is preferably 10 to 200 μm, and in particular preferably 30 to 100 μm. For obtaining the strength of the membrane capable of withstanding practical use, the thickness is preferably larger than 10 μm. For reducing the membrane resistance, i.e., improving the electricity generation performance, the thickness is preferably smaller than 200 μm.

In the present invention, it is essential only that the ion exchange group equivalent weight of one electrolyte layer of the electrolyte membrane having a porous layer including at least one layer of a porous material impregnated with an electrolyte on inner sides of a pair of electrolyte layers is larger than the ion exchange group equivalent weight of the other electrolyte layer. The value of the ion exchange group equivalent weight, and the number of the electrolyte layers having different ion exchange group equivalent weights have no particular restriction. The ion exchange group herein referred to has no particular restriction so long as it conducts ions. Specifically, mention may be made of a sulfonic acid group, a phosphonic acid group, a carboxylic acid group, a sulfonamide group, a sulfonimide group, an alkyl sulfonic acid group, an alkyl phosphonic acid group, or an alkyl carboxylic acid group. Further, the counter ions of these proton conductive substituents are not necessarily limited to proton. It does not matter if a small amount of ammonium ions or metal ions are contained therein.

In the present invention, different electrolytes may be used so long as the ion exchange group equivalent weight of one electrolyte layer of the electrolyte membrane having a porous layer including at least one layer of a porous material impregnated with an electrolyte on inner sides of a pair of electrolyte layers is larger than the ion exchange group equivalent weight of the other. The number of types of electrolytes has no particular restriction. The ion exchange group equivalent weight of the solid polymer electrolyte for use in the present invention is 250 to 2500 g/equivalent. The ion exchange group equivalent weight is preferably 300 to 1500 g/equivalent, and further preferably 530 to 970 g/equivalent. When the ion exchange group equivalent weight exceeds 2500 g/equivalent, the output performance may be reduced. Whereas, when it is lower than 250 g/equivalent, the water resistance of the polymer is reduced. The respective cases are not preferable.

Incidentally, the ion exchange group equivalent weight of the present invention represents the molecular weight of the polymer per unit equivalent weight of the ion exchange group introduced. A smaller value indicates a larger degree of introduction of the ion exchange group. The ion exchange group equivalent weight can be measured by ¹H-NMR spectroscopy, elementary analysis, acid base titration described in Japanese Examined Patent Application Publication No. 1-52866, non-aqueous acid base titration (the normal solution is a benzene/methanol solution of potassium methoxide), or the like.

In the present invention, it is essential only that the number average molecular weight of one electrolyte layer of the electrolyte membrane having a porous layer including at least one layer of a porous material impregnated with an electrolyte on inner sides of a pair of electrolyte layers is larger than the number average molecular weight of the other. The number average molecular weight of the solid polymer electrolyte for use in the present invention is 10000 to 200000 in terms of the polystyrene equivalent number average molecular weight by a GPC method. It is preferably 20000 to 170000, and further preferably 25000 to 150000. When it is smaller than 10000, the strength of the electrolyte membrane may be reduced. Whereas, when it exceeds 150000, the output performance may be reduced. The respective cases are not preferable.

In accordance with the present invention, it is possible to provide a long life solid polymer electrolyte composite membrane.

### BRIEF DESCRIPTION OF THE DRAWINGS

FIG. 1 is a cross sectional view of a solid polymer electrolyte membrane in accordance with the present invention;

FIG. 2 is a view of a direct methanol type fuel cell electricity production apparatus in accordance with the present invention; and

FIG. 3 is a solid polymer type hydrogen-oxygen type fuel cell electricity production apparatus in accordance with the present invention.

### DETAILED DESCRIPTION OF THE PREFERRED EMBODIMENTS

Below, the present invention will be described in more details by way of examples, which should not be construed as limiting the scope of the present invention.

### EXAMPLE 1

### (Manufacturing of Electrolyte Composite Membrane)

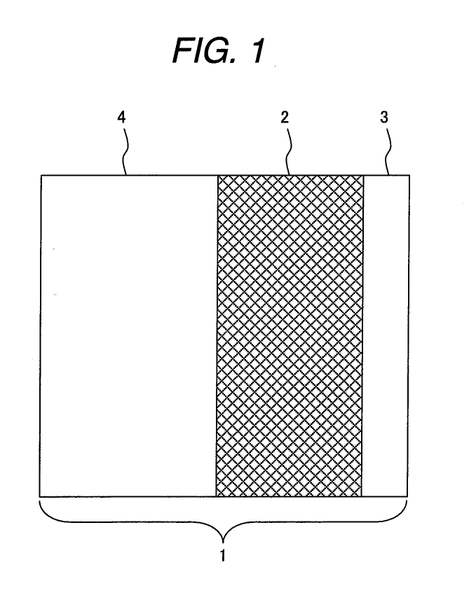

Sulfonated polyether sulfone (S-PES) with a number average molecular weight of 4×10⁴ and an ion exchange equivalent weight of 8×10² g/equivalent was dissolved in N,N-dimethylacetamide to manufacture a 30 wt % electrolyte solution. The electrolyte solution was cast and coated on a glass substrate. A polyolefin porous membrane was placed thereon, and impregnated therewith. Further, an electrolyte solution was cast and coated from thereabove. At this step, by controlling the amount of the electrolyte to be cast, the thicknesses of the electrolyte layers on the opposite sides of the polymer layer were changed. Thereafter, heating and drying were carried out at 80° C. for 20 minutes, and then at 120° C. for 20 minutes, thereby to remove the solvent in the solution. As a result, there was manufactured a solid polymer electrolyte composite membrane having a porous layer on the inner sides of a pair of electrolyte layers in which the thickness of one electrolyte layer is larger than the thickness of the other electrolyte layer. FIG. 1 shows a cross sectional view of a configuration of the solid polymer electrolyte composite membrane. A reference numeral 1 represents an electrolyte composite membrane; 2, a porous layer; 3, an electrolyte layer; and 4, an electrolyte layer having a larger thickness than that of the electrolyte layer 3. The observation of the cross-section of the resulting electrolyte composite membrane indicates as follows: the total thickness of the electrolyte composite membrane is 40 μm, the thickness of the electrolyte layer 4 is 20 μm, and the thickness of the electrolyte layer 3 is 5 μm.

### (Manufacturing of Membrane Electrode Assembly)

For a fuel electrode, an electrode catalyst including Pt and Ru carried in each amount of 25 wt % on carbon black was used. Whereas, for an air electrode, an electrode catalyst having Pt in an amount of 50 wt % carried thereon was used. To each electrode catalyst, a Nafion solution was weighed and mixed in a ratio such that the weight ratio of the electrode catalyst and Nafion was 1 to 9, thereby to manufacture an electrode catalyst paste. The electrode catalyst paste was spray coated on the electrolyte membrane to form an electrode catalyst layer. At this step, an air electrode catalyst layer was formed on the electrolyte layer having a larger thickness, and a fuel electrode catalyst layer was formed on the other.

### EXAMPLE 2

### (Manufacturing of Electrolyte Composite Membrane)

Sulfonated polyether sulfone with a number average molecular weight of 4×10⁴, and an ion exchange equivalent weight of 11×10² g/equivalent was dissolved in N,N-dimethylacetamide to manufacture a 30 wt % electrolyte solution. The electrolyte solution was cast and coated on a glass substrate. A polyolefin porous membrane was placed thereon, and impregnated therewith. Further, the electrolyte solution formed in Example 1 was cast and coated from thereabove. Thereafter, heating and drying were carried out at 80° C. for 20 minutes, and then at 120° C. for 20 minutes, thereby to remove the solvent in the solution. As a result, there was manufactured a solid polymer electrolyte composite membrane having a porous layer on the inner sides of a pair of electrolyte layers in which the ion exchange equivalent weight of one electrolyte layer is larger than the ion exchange equivalent weight of the other electrolyte layer. The observation of the cross section of the resulting electrolyte composite membrane indicates as follows: the total thickness of the electrolyte composite membrane is 40 μm, and each thickness of the electrolyte layers is 12 μm.

### (Manufacturing of Membrane Electrode Assembly)

Manufacturing was carried out in the same manner as in Example 1. In the process, an air electrode catalyst layer was formed at the electrolyte layer having a larger ion exchange equivalent weight, and a fuel electrode catalyst layer was formed at the other.

### EXAMPLE 3

### (Manufacturing of Electrolyte Composite Membrane)

Sulfonated polyether sulfone with a number average molecular weight of 7×10⁴ and an ion exchange equivalent weight of 8×10² g/equivalent was dissolved in N,N-dimethylacetamide to manufacture a 30 wt % electrolyte solution. The electrolyte solution was cast and coated on a glass substrate. A polyolefin porous membrane was placed thereon, and impregnated therewith. Further, the electrolyte solution formed in Example 1 was cast and coated from thereabove. Thereafter, heating and drying were carried out at 80° C. for 20 minutes, and then at 120° C. for 20 minutes, thereby to remove the solvent in the solution. As a result, there was manufactured a solid polymer electrolyte composite membrane having a porous layer on the inner sides of a pair of electrolyte layers in which the average molecular weight of one electrolyte layer is larger than the average molecular weight of the other electrolyte layer. The observation of the cross section of the resulting electrolyte composite membrane indicates as follows: the total thickness of the electrolyte composite membrane is 40 μm, and each thickness of the electrolyte layers is 12 μm.

### (Manufacturing of Membrane Electrode Assembly)

Manufacturing was carried out in the same manner as in Example 1. In the process, an air electrode catalyst layer was formed at the electrolyte layer having a larger average molecular weight, and a fuel electrode catalyst layer was formed at the other.

### EXAMPLE 4

### (Manufacturing of Electrolyte Composite Membrane)

Sulfonated polyether sulfone (S-PES) with a number average molecular weight of 9×10⁴ and an ion exchange equivalent weight of 7×10² g/equivalent was dissolved in N,N-dimethylacetamide to manufacture a 23 wt % electrolyte solution. The electrolyte solution was cast and coated on a glass substrate. A polyolefin porous membrane was placed thereon, and impregnated therewith. Further, the electrolyte solution formed in Example 1 was cast and coated from thereabove. Thereafter, heating and drying were carried out at 80° C. for 20 minutes, and then at 120° C. for 20 minutes, thereby to remove the solvent in the solution. As a result, there was manufactured a solid polymer electrolyte composite membrane having a porous layer on the inner sides of a pair of electrolyte layers in which the average molecular weight of one electrolyte layer is larger than the average molecular weight of the other electrolyte layer. The observation of the cross section of the resulting electrolyte composite membrane indicates as follows: the total thickness of the electrolyte composite membrane is 40 μm, and each thickness of the electrolyte layers is 12 μm.

### (Manufacturing of Membrane Electrode Assembly)

Manufacturing was carried out in the same manner as in Example 1. In the process, an air electrode catalyst layer was formed at the SM-PES electrolyte layer, and a fuel electrode catalyst layer was formed at the other.

### COMPARATIVE EXAMPLE 1

The electrolyte solution manufactured in Example 1 was cast and coated on a glass substrate. A polyolefin porous membrane was placed thereon, and impregnated therewith. Further, the electrolyte solution was cast and coated from thereabove. Thereafter, heating and drying were carried out at 80° C. for 20 minutes, and then at 120° C. for 20 minutes, thereby to remove the solvent in the solution. As a result, there was manufactured a solid polymer electrolyte composite membrane having a porous layer on the inner sides of a pair of electrolyte layers in which the thickness of one electrolyte layer is equal to the thickness of the other electrolyte layer. The observation of the cross section of the resulting electrolyte composite membrane indicates as follows: the total thickness of the electrolyte composite membrane is 40 μm, and each thickness of the electrolyte layers is 12 Mm.

### (DMFC Cell Performance Evaluation)

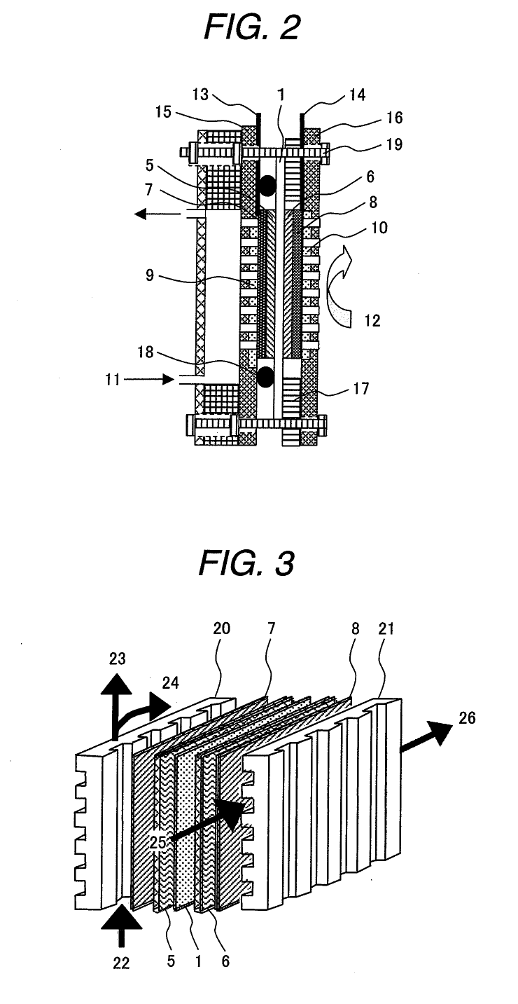

The DMFC electricity production apparatus single cell shown in FIG. 2 was used, and each membrane electrode assembly manufactured in Examples 1 to 3, and Comparative Example 1 was mounted therein. Thus, the cell performances were measured. In FIG. 1, a reference numeral 1 represents a polymer electrolyte membrane; 5, an anode; 6, a cathode; 7, an anode diffusion layer; 8, a cathode diffusion layer; 9, an anode collector; 10, a cathode collector; 11, fuel; 12, air; 13, an anode terminal; 14, a cathode terminal; 15, an anode end plate; 16, a cathode end plate; 17, a gasket; 18, an O-ring; and 19, bolt/nut. As a fuel, a 10 wt % methanol solution was circulated on the fuel electrode side, and air was fed to the air electrode side in a natural exhalation form. Continuous operation was carried out at 35° C. under a load of 50 mA/cm².

Table 1 shows the results when the DMFC continuous electricity production test has been carried out by the use of each membrane electrode assembly manufactured in Examples 1 to 3, and Comparative Example 1. As apparent from Table 1, the DMFC using the solid polymer electrolyte composite membrane according to the present invention has a longer life as compared with the electrolyte membrane of Comparative Example. The same results can also be expected for a PEFC continuous test.

TABLE 1

| | | | | | Comparative |
|---|---|---|---|---|---|
| Item | Example 1 | Example 2 | Example 3 | Example 4 | Example 1 |
| Total thickness of electrolyte composite membrane (μm) | 40 | 40 | 40 | 40 | 40 |
| Type of electrolyte adjacent to air electrode catalyst | S-PES | S-PES | S-PES | SM-PES | S-PES |
| layer | | | | | |
| Thickness of electrolyte layer adjacent to air | 20 | 12 | 12 | 12 | 12 |
| electrode catalyst layer (μm) | | | | | |
| Ion exchange equivalent weight of electrolyte layer | 8 × 10² | 11 × 10² | 8 × 10² | 7 × 10² | 8 × 10² |
| adjacent to air electrode catalyst layer | | | | | |
| (g/equivalent) | | | | | |
| Number average molecular weight of electrolyte layer | 4 × 10⁴ | 4 × 10⁴ | 7 × 10⁴ | 9 × 10⁴ | 4 × 10⁴ |
| adjacent to air electrode catalyst layer | | | | | |
| Type of electrolyte adjacent to air electrode catalyst | S-PES | S-PES | S-PES | S-PES | S-PES |
| layer | | | | | |
| Thickness of electrolyte layer adjacent to fuel | 4 | 12 | 12 | 12 | 12 |
| electrode catalyst layer (μm) | | | | | |
| Ion exchange equivalent weight of electrolyte layer | 8 × 10² | 8 × 10² | 8 × 10² | 8 × 10² | 8 × 10² |
| adjacent to fuel electrode catalyst layer | | | | | |
| (g/equivalent) | | | | | |
| Number average molecular weight of electrolyte layer | 4 × 10⁴ | 4 × 10⁴ | 4 × 10⁴ | 4 × 10⁴ | 4 × 10⁴ |
| adjacent to fuel electrode catalyst layer | | | | | |
| Initial voltage (V) | 0.35 | 0.33 | 0.37 | 0.38 | 0.34 |
| Ratio of electricity production time until voltage | >1.5 | >1.2 | >1.2 | >1.2 | 1 |
| is reduced to 0.3 V (Example/Comparative Example) | | | | | |

### (PEFC Cell Performance Evaluation)

The compact single cell using hydrogen as a fuel shown in FIG. 3 was used, and each membrane electrode assembly manufactured in Example 1 and Comparative Example 1 was mounted therein. Thus, the cell performances were measured. In FIG. 3, a reference numeral 1 represents a polymer electrolyte membrane; 5, an anode; 6, a cathode; 7, an anode diffusion layer; 8, a cathode diffusion layer; 20, a fuel passage of an electrically conductive separator (bipolar plate) for pole chamber separation, and also serving as a gas feed channel to the electrode; 21, a passage for air of an electrically conductive separator (bipolar plate) for pole chamber separation, and also serving as a gas feed channel to the electrode; 22, hydrogen of the fuel and water; 23, hydrogen; 24, water; 25, air; and 26, air and water. The compact single cell was set in a thermostat, and the temperature of the thermostat was controlled such that the temperature by a thermocouple (not shown) inserted into the separator was 70° C. For humidification of the anode and the cathode, an external humidifier was used. Thus, the temperature of the humidifier was controlled within the range between 70 to 73° C. such that the dew point at the vicinity of the outlet of the humidifier was 70° C. For the dew point, other than the measurement by a dew-point hygrometer, the amount of wetting water consumed was continuously measured. Thus, the dew point determined from the flow rate, temperature, and pressure of a reaction gas was confirmed to be a prescribed value. By setting the load current density at 250 mA/cm², the hydrogen utilization rate at 70%, the air utilization rate at 40%, electricity was produced at about 8 hours/day, and hot keep operation was carried out during the residual time.

Table 2 shows the results when the PEFC continuous electricity production test has been carried out by the use of each membrane electrode assembly manufactured in Example 1 and Comparative Example 1. As apparent from Table 2, the PEFC using the solid polymer electrolyte composite membrane according to the present invention has a longer life as compared with the electrolyte membrane of Comparative Example.

TABLE 2

| | | Comparative |
|---|---|---|
| Item | Example 1 | Example 1 |
| Total thickness of electrolyte composite | 40 | 40 |
| membrane (μm) | | |
| Type of electrolyte adjacent to air electrode | S-PES | S-PES |
| catalyst layer | | |
| Thickness of electrolyte layer adjacent to air | 20 | 12 |
| electrode catalyst layer (μm) | | |
| Ion exchange equivalent weight of electrolyte | 8 × 10² | 8 × 10² |
| layer adjacent to air electrode catalyst layer | | |
| (g/equivalent) | | |
| Number average molecular weight of | 4 × 10⁴ | 4 × 10⁴ |
| electrolyte layer adjacent to air electrode | | |
| catalyst layer | | |
| Type of electrolyte adjacent to air electrode | S-PES | S-PES |
| catalyst layer | | |
| Thickness of electrolyte layer adjacent to fuel | 4 | 12 |
| electrode catalyst layer (μm) | | |
| Ion exchange equivalent weight of electrolyte | 8 × 10² | 8 × 10² |
| layer adjacent to fuel electrode catalyst | | |
| layer (g/equivalent) | | |
| Number average molecular weight of | 4 × 10⁴ | 4 × 10⁴ |
| electrolyte layer adjacent to fuel electrode | | |
| catalyst layer | | |
| Ratio of electricity production time until | >1.1 | 1 |
| voltage is reduced by 10% | | |
| (Example/Comparative Example) | | |

The polymer electrolyte composite membrane of the present invention can be used not only for a hydrogen-oxygen fuel cell but also for a DMFC of the type using alcohol for a fuel, and directly feeding it to the fuel cell.

What is claimed is:

1. An electrolyte membrane for a methanol fuel cell, comprising a first electrolyte layer having an ion conductivity, a second electrolyte layer having an ion conductivity and being thicker than the first electrolyte layer, and a porous layer having an ion conductive electrolyte impregnated therein, formed between the first electrode layer and the second electrode layer.

2. An electrolyte membrane for a methanol fuel cell, comprising a first electrolyte layer having an ion conductivity, a second electrolyte layer having an ion conductivity and having a larger ion exchange equivalent than that of the first electrolyte layer, and a porous layer having an ion conductive electrolyte impregnated therein, formed between the first electrode layer and the second electrode layer.

3. An electrolyte membrane for a methanol fuel cell, comprising a first electrolyte layer having an ion conductivity, a second electrolyte layer having an ion conductivity and having a larger number average molecular weight than that of the first electrolyte layer, and a porous layer having an ion conductive electrolyte impregnated therein, formed between the first electrode layer and the second electrode layer.

4. The solid polymer electrolyte membrane according to claim 2, wherein the first electrolyte is a hydrocarbon electrolyte layer, and the second electrolyte layer is a hydrocarbon electrolyte layer having a different chemical formula.

5. The solid polymer electrolyte membrane according to claim 1, wherein the solid polymer electrolyte membrane is an aromatic hydrocarbon polymer electrolyte having an ion exchange group.

6. The solid polymer electrolyte membrane according to claim 1, wherein the solid polymer electrolyte membrane is polyether sulfone having an ion exchange group.

7. The solid polymer electrolyte membrane according to claim 6, wherein the ion exchange group is a sulfonic acid group.

8. The solid polymer electrolyte membrane according to claim 1, wherein the ratio of the thickness of the first electrolyte layer and the thickness of the second electrolyte layer is 1:10 to 4:5.

9. The solid polymer electrolyte membrane according to claim 1, wherein the thickness of the first electrolyte layer is 5 to 40 μm, and the thickness of the second electrolyte layer is 10 to 50 μm.

10. A membrane electrode assembly according to claim 1, comprising the solid polymer electrolyte membrane, wherein an air electrode catalyst layer is formed adjacent to the second electrolyte layer, and a fuel electrode catalyst layer is formed adjacent to the first electrolyte layer.

11. A membrane electrode assembly according to claim 2, comprising the solid polymer electrolyte membrane, wherein an air electrode catalyst layer is formed adjacent to the second electrolyte layer, and a fuel electrode catalyst layer is formed adjacent to the first electrolyte layer.

12. A membrane electrode assembly according to claim 3, comprising the solid polymer electrolyte membrane, wherein an air electrode catalyst layer is formed adjacent to the second electrolyte layer, and a fuel electrode catalyst layer is formed adjacent to the first electrolyte layer.

13. A fuel cell having the membrane electrode assembly according to claim 10.
